(19) United States
(12) Patent Application Publication
(10) Pub. No.: US 2026/0298360 A1
(43) Pub. Date: Oct. 1, 2026

(54) MAGNETIC INFLATION DEVICE AND INFLATING AND DEFLATING METHOD THEREOF

(71) Applicants: Jian Song, Dongguan (CN); Junping Ma, Luoyang (CN)

(72) Inventors: Jian Song, Dongguan (CN); Junping Ma, Luoyang (CN)

(21) Appl. No.: 19/328,117

(22) Filed: Sep. 13, 2025

(30) Foreign Application Priority Data
Mar. 31, 2025 (CN) 202510393199.7

(51) Int. Cl. F16K 15/20; F16K 31/06; F16K 31/08

(52) U.S. Cl. CPC F16K 15/20; F16K 31/0655; F16K 31/08; F16K 2200/30

(57) ABSTRACT

A magnetic inflation device includes an inflating base, including an inflating base main body, a valve core, an elastic member and a first magnetic member; and an inflating head, including an inflating head main body defining a third gas channel. The inflating base main body defines a valve cavity, a first gas channel and a second gas channel connected to the valve cavity. The valve core and the elastic member are mounted in the valve cavity, and a lower end of the valve core extends into the first gas channel. The elastic member applies elastic force to the valve core to force it to press downwards to close the first gas channel. The first magnetic member is mounted in the inflating base main body. A second magnetic member is mounted in the inflating head main body, and the second magnetic member is magnetically matched with the first magnetic member.

### TECHNICAL FIELD

The disclosure relates to the technical field of inflation devices of inflatable products, and more particularly to a magnetic inflation device and an inflating and deflating method thereof.

### BACKGROUND

At present, inflatable kayaks, inflatable pads, inflatable dolls, swimming rings, inflatable vibrators, inflatable anal plugs and other inflatable products all require a use of inflation devices. The inflation devices usually include an inflating base and an inflating head. The inflating base is mounted on the inflatable product, and the inflating head is connected to a gas supply device. When it is necessary to inflate the inflatable product, the inflating head is connected to the inflating base, and the gas supply device can inflate the inflatable product through the inflating head and the inflating base. In the related art, the inflation devices mainly include the following two structures. A first type of inflation device is to define an inflating hole in the inflating base, and set an anti-reversal mechanism in the inflating hole. The inflating head is needle shaped, and after inserting the inflating head into the inflating hole of the inflating base, the inflatable product can be inflated. After inflation is completed, the inflating head is removed, and the anti-reversal mechanism blocks the inflating hole under pressure inside the inflatable product. However, this type of inflation device has the following problems. 1) The anti-reversal mechanism relies on the pressure inside the inflatable product to achieve anti-reversal. When a pressure difference between the inside and outside of the inflatable product is small, the anti-reversal mechanism is difficult to achieve the anti-reversal effect and is prone to air leakage. 2) This type of inflation device is not convenient for manual deflation. 3) When inflating by using this type of inflation device, users need to carefully locate the pin inflating hole and then insert the needle shaped inflating head, which is very difficult to operate and may damage the product if inserted too deeply. A second type of inflation device is to mount an electromagnetic valve in the inflating base and mount a connecting member on the inflating head. When inflation is needed, the inflating head is aligned with the inflating base and is connected to the inflating base through the connecting member. Then, the electromagnetic valve is opened to inflate. After inflation is complete, the electromagnetic valve is closed, and the connecting member of the inflating head is released. However, this type of inflation device has the following problems. 1) The electromagnetic valve needs to be connected to a power supply, and it is difficult to be used without a power supply. 2) The connection between the inflating head and the inflating base is cumbersome and not fast enough. 3) This type of inflation device requires both the steps of connecting the inflating head and the inflating base, as well as the steps of controlling the opening and closing of the electromagnetic valve, resulting in poor operational convenience.

### SUMMARY

A technical problem of the disclosure to be solved is to provide a magnetic inflation device that addresses shortcomings of the related art. The magnetic inflation device can use magnetic attraction to connect an inflating head and an inflating base, and at the same time, lift up a valve core while connecting the inflating head and the inflating base to open up gas channels to achieve inflation. After pulling open the inflating head, the valve core can be forced to close the gas channels under an action of an elastic member, which has good airtightness, is not easy to leak, and is easy to operate. On the other hand, when a first magnetic member and a second magnetic member of the magnetic inflation device use permanent magnets, there is no need to connect to an external power supply and are not limited by the power supply. The disclosure also provides an inflating and deflating method of the magnetic inflation device.

In order to solve the above first technical problem, a technical solution of the disclosure is a magnetic inflation device, including an inflating base and an inflating head. The inflating base includes an inflating base main body, a valve core, an elastic member and a first magnetic member. The inflating base main body defines a valve cavity therein, and the inflating base main body defines a first gas channel and a second gas channel connected to the valve cavity. The valve core and the elastic member are mounted in the valve cavity, and a lower end of the valve core extends into the first gas channel. The elastic member is configured to apply elastic force to the valve core to force the valve core to press downwards to close the first gas channel. The first magnetic member is mounted in the inflating base main body. The inflating head includes an inflating head main body. The inflating head main body is configured to dock or separate from the inflating base main body. The inflating head main body defines a third gas channel cooperating with the first gas channel, and an upper end of the third gas channel is configured to lift the lower end of the valve core upwards and force the valve core to move upwards against the elastic force of the elastic member to open the first gas channel. A second magnetic member is mounted in the inflating head main body, the second magnetic member is magnetically matched with the first magnetic member, and magnetic force between the first magnetic member and the second magnetic member is greater than the elastic force applied by the elastic member to the valve core.

In the above technical solution, a middle of the valve core is provided with a valve core sheet body protruding outwards. A lower side of the valve core sheet body defines a first annular positioning groove. A first sealing ring is mounted in the first annular positioning groove, a lower side of the first sealing ring is configured to cooperate with a top of the first gas channel, and the first sealing ring is sealed with the top of the first gas channel when the valve core is pressed down.

In the above technical solution, a cylinder is disposed on the lower end of the valve core, and the cylinder defines a cylinder middle hole. An upper end of the cylinder defines multiple first gas passage holes connected to the cylinder middle hole, and each of the multiple first gas passage holes is located on a lower side of the first annular positioning groove.

In the above technical solution, an upper end of the first gas channel defines an annular gas passage groove, and a position of the annular gas passage groove corresponds to a position of the multiple first gas passage holes. A lower end of the cylinder defines multiple second gas passage holes connected to the cylinder middle hole, and the multiple second gas passage holes are located below the multiple first gas passage holes.

In the above technical solution, the elastic member is a spring, and the spring is sleeved on an upper end of the valve core. A lower end of the spring is abutted against an upper side of the valve core sheet body, and an upper end of the spring is abutted against a top of the valve cavity.

In the above technical solution, multiple ribs are convexly disposed on an inner wall of the valve cavity, and an outer side of the valve core sheet body is in sliding contact with the multiple ribs.

In the above technical solution, the inflating base main body includes an inflating base body and an inflating base cover body. The inflating base cover body covers a lower side of the inflating base body, and a second sealing ring is mounted between the inflating base cover body and the inflating base body. The valve cavity is located in the inflating base body, the first gas channel is defined on a middle part of the inflating base cover body, and the second gas channel is defined on an upper part of the inflating base body.

In the above technical solution, the inflating base body and the inflating base cover body are clamped or bonded with each other. The inflating base cover body defines a first annular magnet groove, and the first annular magnet groove is located on an outer periphery of the first gas channel. The first magnetic member is an annular magnet, and the first magnetic member is mounted in the first annular magnet groove. The inflating head main body defines a second annular magnet groove, and the second annular magnet groove is located on an outer periphery of the third gas channel. The second magnetic member is an annular magnet, and the second magnetic member is mounted in the second annular magnet groove. A magnet groove cover body is disposed in the second annular magnet groove, and the magnet groove cover body covers a lower side of the second magnetic member and is tightly matched with the second annular magnet groove.

In the above technical solution, an upper end of the inflating head main body defines a second annular positioning groove, and the second annular positioning groove is located on an outer periphery of the upper end of the third gas channel. A third sealing ring is mounted in the second annular positioning groove, and an upper side of the third sealing ring is abutted against a bottom of the first gas channel when the upper end of the third gas channel lifts the lower end of the valve core upwards.

In order to solve the above second technical problem, a technical solution of the disclosure is an inflating and deflating method of the magnetic inflation device, including:
step I, performing a mounting process, including: mounting the inflating base on an inflatable product to make the first gas channel of the inflating base main body face towards an outside of the inflatable product, and make the second gas channel of the inflating base main body face towards an inside of the inflatable product; and connecting the inflating head and a gas supply device;
step II, performing an inflating process, including:
   step i, placing an upper end of the inflating head close to a lower end of the inflating base, so that the inflating head and the inflating base are closely attracted together under a magnetic attraction effect of the first magnetic member and the second magnetic member, an upper end of the third gas channel synchronously lifts the lower end of the valve core in the first gas channel upwards to force the valve core to move upwards against the elastic force of the elastic member to open the first gas channel and connect the third gas channel and the first gas channel;
   step ii, starting the gas supply device to make gas sequentially pass through the third gas channel, the first gas channel, the valve cavity and the second gas channel, and then enter the inside of the inflatable product until inflation is completed; and
   step iii, pulling open the inflating head, so that the valve core is pressed downwards under the elastic force of the elastic member to close the first gas channel; and
step III, performing a deflating process, including: when the inflatable product needs to be deflated, pressing the lower end of the valve core in the first gas channel upwards by a hand or an object to force the valve core to move upwards against the elastic force of the elastic member to open the first gas channel, to make the gas in the inflatable product sequentially pass through the second gas channel, the valve cavity and the first gas channel to be discharged to the outside of the inflatable product.

Beneficial effects of the disclosure are as follows. The disclosure can use magnetic attraction to connect the inflating head and the inflating base, and at the same time, lift up the valve core while connecting the inflating head and the inflating base to open up the gas channels to achieve inflation. After pulling open the inflating head, the valve core can be forced to close the gas channels under the action of the elastic member, which has good airtightness, is not easy to leak, and is easy to operate. When the first magnetic member and the second magnetic member of the magnetic inflation device use permanent magnets, there is no need to connect to the external power supply and are not limited by the power supply.

### BRIEF DESCRIPTION OF DRAWINGS

FIG. 1 illustrates a schematic structural diagram from a first perspective of an inflating base and an inflating head of a magnetic inflation device in a separation state according to an embodiment of the disclosure.

FIG. 2 illustrates a schematic structural diagram from a second perspective of the inflating base and the inflating head of the magnetic inflation device in the separation state according to an embodiment of the disclosure.

FIG. 3 illustrates a schematic longitudinal sectional structural diagram of the inflating base and the inflating head of the magnetic inflation device in the separation state according to an embodiment of the disclosure.

FIG. 4 illustrates an exploded structural diagram from the first perspective of the inflating base of the magnetic inflation device according to an embodiment of the disclosure.

FIG. 5 illustrates an exploded structural diagram from the second perspective of the inflating base of the magnetic inflation device according to an embodiment of the disclosure.

FIG. 6 illustrates an exploded structural diagram from the first perspective of the inflating head of the magnetic inflation device according to an embodiment of the disclosure.

FIG. 7 illustrates an exploded structural diagram from the second perspective of the inflating head of the magnetic inflation device according to an embodiment of the disclosure.

FIG. 8 illustrates a schematic structural diagram of the inflating base and the inflating head of the magnetic inflation device in a docking state according to an embodiment of the disclosure.

FIG. 9 illustrates a schematic structural diagram of an inflatable anal plug with the inflating base and a compression inflation pump with an inflating head in a docking state according to an embodiment of the disclosure.

### DETAILED DESCRIPTION OF EMBODIMENTS

A structural principle and a working principle of the disclosure are further illustrated in detail in conjunction with drawings below.

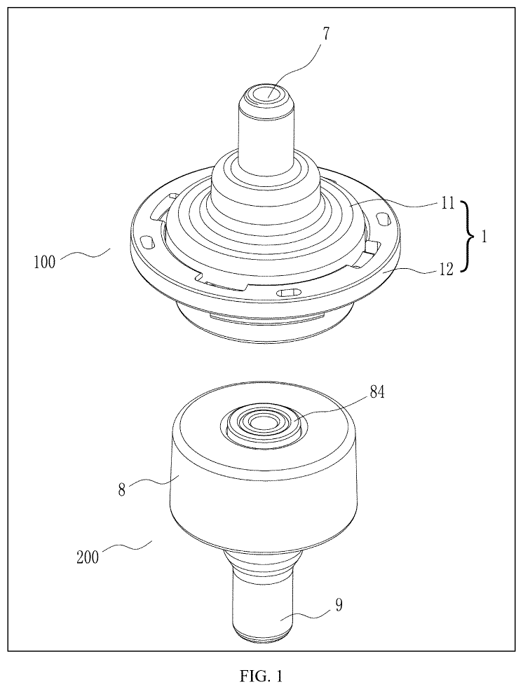

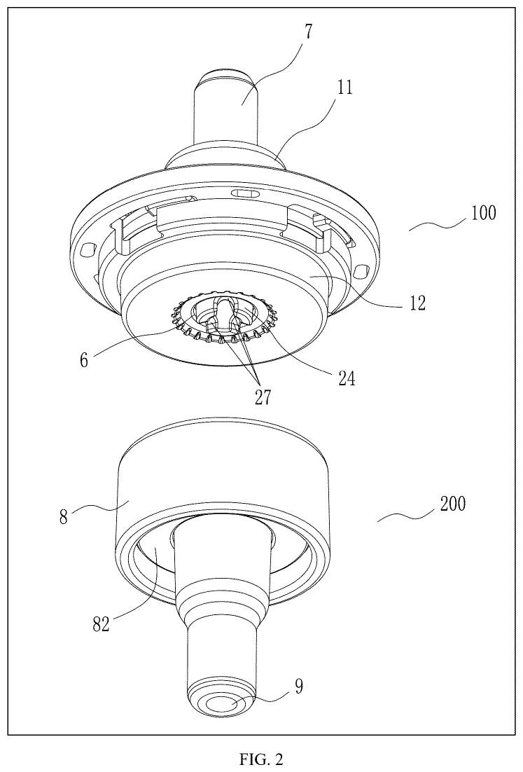

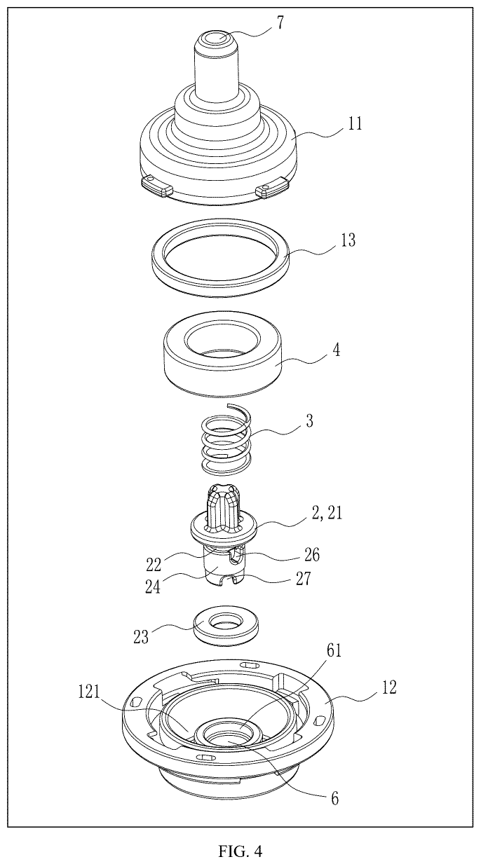

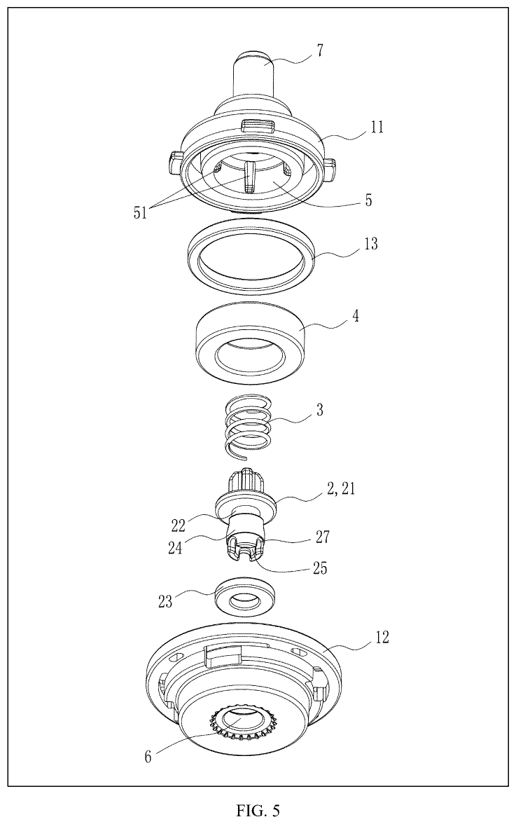

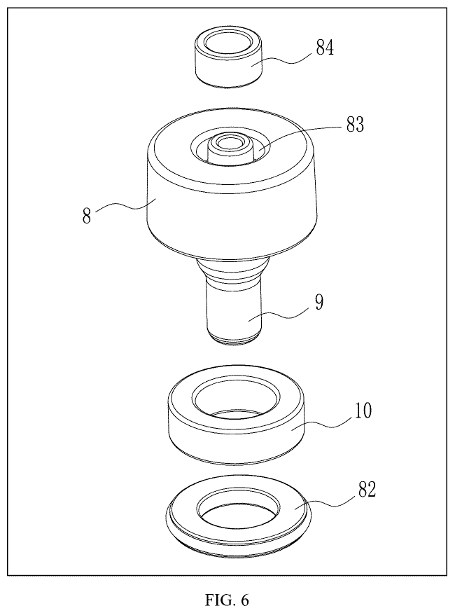

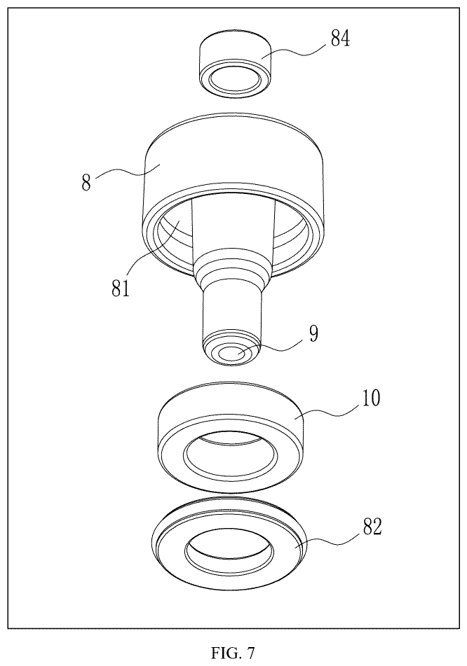

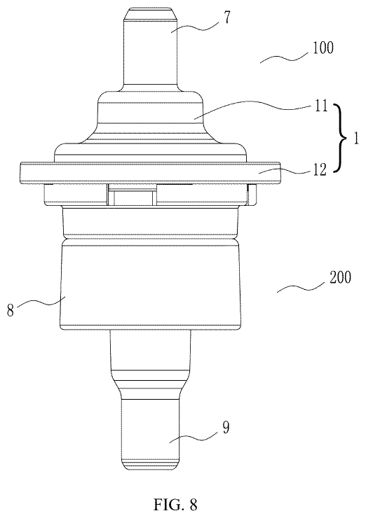

As shown in FIGS. 1-8, the disclosure provides a magnetic inflation device, including an inflating base 100 and an inflating head 200. The inflating base 100 includes an inflating base main body 1, a valve core 2, an elastic member 3 and a first magnetic member 4. The inflating base main body 1 defines a valve cavity 5 therein, and the inflating base main body 1 defines a first gas channel 6 and a second gas channel 7 connected to the valve cavity 5. The valve core 2 and the elastic member 3 are mounted in the valve cavity 5, and a lower end of the valve core 2 extends into the first gas channel 6. The elastic member 3 is configured to apply elastic force to the valve core 2 to force the valve core 2 to press downwards to close the first gas channel 6. The first magnetic member 4 is mounted in the inflating base main body 1. The inflating head 200 includes an inflating head main body 8. The inflating head main body 8 is configured to dock or separate from the inflating base main body 1. The inflating head main body 8 defines a third gas channel 9 cooperating with the first gas channel 6, and an upper end of the third gas channel 9 is configured to lift the lower end of the valve core 2 upwards and force the valve core 2 to move upwards against the elastic force of the elastic member 3 to open the first gas channel 6. A second magnetic member 10 is mounted in the inflating head main body 8, the second magnetic member 10 is magnetically matched with the first magnetic member 4, and magnetic force between the first magnetic member 4 and the second magnetic member 10 is greater than the elastic force applied by the elastic member 3 to the valve core 2.

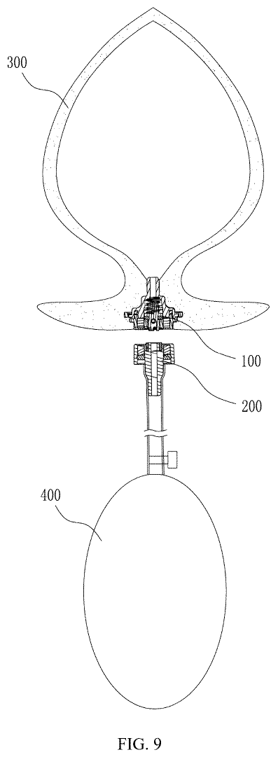

Referring to FIGS. 1-8 with reference to FIG. 9, the disclosure provides an inflating and deflating method of the magnetic inflation device, including the following steps I-III.

In step I, a mounting process is performed. The inflating base 100 is mounted on an inflatable kayak, an inflatable pad, an inflatable doll, a swimming ring, an inflatable vibrator, an inflatable anal plug or other inflatable products to make the first gas channel 6 of the inflating base main body 1 face towards an outside of the inflatable product, and make the second gas channel 7 of the inflating base main body 1 face towards an inside of the inflatable product. in the embodiment, as shown in FIG. 9, the inflatable product is an inflatable anal plug 300. The inflating head 200 is connected to a gas supply device. In the embodiment, the gas supply device is a compression inflation pump 400.

In step II, an inflating process is performed. Step i, an upper end of the inflating head 200 is placed close to a lower end of the inflating base 100, so that the inflating head 200 and the inflating base 100 are closely attracted together under a magnetic attraction effect of the first magnetic member 4 and the second magnetic member 10. At the same time, an upper end of the third gas channel 9 lifts the lower end of the valve core 2 in the first gas channel 6 upwards to force the valve core 2 to move upwards against the elastic force of the elastic member 3 to open the first gas channel 6 and connect the third gas channel 9 and the first gas channel 6. Step ii, the gas supply device is started to make gas sequentially pass through the third gas channel 9, the first gas channel 6, the valve cavity 5 and the second gas channel 7, and then enter the inside of the inflatable product until inflation is completed. Step iii, the inflating head 200 is pulled open, so that the valve core 2 is pressed downwards under the elastic force of the elastic member 3 to close the first gas channel 6.

In step III, a deflating process is performed. When the inflatable product needs to be deflated, the lower end of the valve core 2 in the first gas channel 6 is pressed upwards by a hand or an object to force the valve core 2 to move upwards against the elastic force of the elastic member to open the first gas channel 6, to make the gas in the inflatable product sequentially pass through the second gas channel 7, the valve cavity 5 and the first gas channel 6 to be discharged to the outside of the inflatable product.

The disclosure can use magnetic attraction to connect the inflating head 200 and the inflating base 100, and at the same time, lift up the valve core 2 while connecting the inflating head 200 and the inflating base 200 to open up the gas channels to achieve inflation. After pulling open the inflating head 200, the valve core 2 can be forced to close the gas channels under the action of the elastic member 3, which has good airtightness, is not easy to leak, and is easy to operate. When the first magnetic member 4 and the second magnetic member 10 of the magnetic inflation device use permanent magnets, there is no need to connect to the external power supply and are not limited by the power supply.

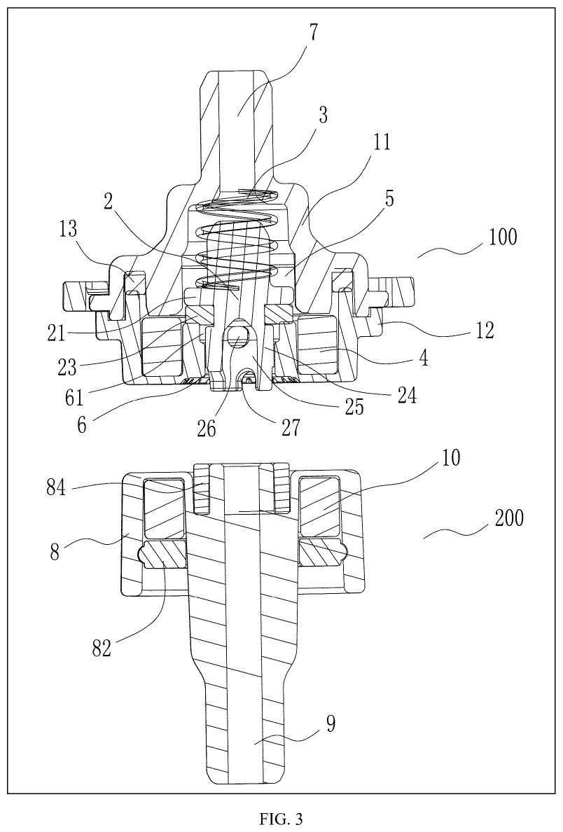

As shown in FIGS. 3-5, a middle of the valve core 2 is provided with a valve core sheet body 21 protruding outwards. A lower side of the valve core sheet body 21 defines a first annular positioning groove 22. A first sealing ring 23 is mounted in the first annular positioning groove 22. By setting the valve core sheet body 21 and the first annular positioning groove 22, the disclosure can stably position the first sealing ring 23, and make the first sealing ring 23 be positioned on the lower side of the valve core sheet body 21. A lower side of the first sealing ring 23 is configured to cooperate with a top of the first gas channel 6, and the first sealing ring 23 is sealed with the top of the first gas channel 6 when the valve core 2 is pressed down. The first sealing ring 23 is separated from the top of the first gas channel 6 when the valve core 2 is moved upwards.

As shown in FIGS. 3-5, a cylinder 24 is disposed on the lower end of the valve core 2, and the cylinder 24 defines a cylinder middle hole 25. An upper end of the cylinder 24 defines multiple first gas passage holes 26 connected to the cylinder middle hole. In an embodiment, the disclosure symmetrically defines two first gas passage holes 26, and each first gas passage hole 26 is located on a lower side of the first annular positioning groove 22. In the inflating process, when the third gas channel 9 is connected to the first gas channel 6, the gas can enter the cylinder 24 of the valve core 2 through the third gas channel 9, and then enter the first gas channel 6 and the valve cavity 5 through the first gas passage holes 26. The lower end of the valve core 2 adopts this structure, which can greatly improve the smoothness of the entire gas channels. In an embodiment, an upper end of the first gas channel 6 defines an annular gas passage groove 61, and a position of the annular gas passage groove 61 corresponds to a position of the first gas passage holes 26. When the gas enters the first gas channel 6 through the first gas passage holes 26, the annular gas passage groove 61 can further improve the smoothness of gas passage. A lower end of the cylinder 24 of the valve core 2 defines multiple second gas passage holes 27 connected to the cylinder middle hole 25, and the multiple second gas passage holes 27 are located below the multiple first gas passage holes 26. A number of the multiple second gas passage holes 27 is three, defining the second gas passage holes 27 can improve the gas flow smoothness during the deflating process, when the lower end of the valve core 2 in the first gas channel 6 is pressed upwards by the hand or the object, the bottom of the valve core 2 may be blocked, the gas can be discharged from the second gas passage holes 27 at this time.

As shown in FIGS. 3-5, the elastic member 3 is a spring, an upper end of the valve core 2 is provided with a spring positioning base, and the spring is sleeved on the spring positioning base on the upper end of the valve core 2. A lower end of the spring is abutted against an upper side of the valve core sheet body 21, and an upper end of the spring is abutted against a top of the valve cavity 5.

As shown in FIGS. 3-5, multiple ribs 51 are convexly disposed on an inner wall of the valve cavity 5, and an outer side of the valve core sheet body 21 is in sliding contact with the multiple ribs 51. After setting the ribs 51, on the one hand, it can reduce frictional force of the valve core sheet body 21 sliding up and down, and on the other hand, it can provide sufficient gap between the valve core sheet body 21 and the inner wall of the valve cavity 5, so that gas can smoothly enter the upper part of the valve core sheet body 21 from below.

As shown in FIGS. 1-5, the inflating base main body 1 includes an inflating base body 11 and an inflating base cover body 12. The inflating base cover body 12 covers a lower side of the inflating base body 11, and a second sealing ring 13 is mounted between the inflating base cover body 12 and the inflating base body 11. The valve cavity 5 is located in the inflating base body 11, the first gas channel 6 is defined on a middle part of the inflating base cover body 12, and the second gas channel 7 is defined on an upper part of the inflating base body 11. The inflating base body 11 and the inflating base cover body 12 are clamped or bonded with each other. The inflating base cover body 12 defines a first annular magnet groove 121, and the first annular magnet groove 121 is located on an outer periphery of the first gas channel 6. The first magnetic member 4 is an annular magnet, and the first magnetic member 4 is mounted in the first annular magnet groove 121. The inflating head main body 8 defines a second annular magnet groove 81, and the second annular magnet groove 81 is located on an outer periphery of the third gas channel 9. The second magnetic member 10 is an annular magnet, and the second magnetic member 10 is mounted in the second annular magnet groove 81. A magnet groove cover body 82 is disposed in the second annular magnet groove 81, and the magnet groove cover body 82 covers a lower side of the second magnetic member 10 and is tightly matched with the second annular magnet groove 81.

As shown in FIGS. 1-3, FIG. 6 and FIG. 7, an upper end of the inflating head main body 8 defines a second annular positioning groove 83, and the second annular positioning groove 83 is located on an outer periphery of the upper end of the third gas channel 9. A third sealing ring 84 is mounted in the second annular positioning groove 83, and an upper side of the third sealing ring 84 is abutted against a bottom of the first gas channel 6 when the upper end of the third gas channel 9 pushes up the lower end of the valve core 2. In the inflating process, when the inflating head 200 and the inflating base 100 are tightly attracted together, the third sealing ring 84 can tightly press against the bottom of the first gas channel 6 to prevent gas leakage.

The above is only some of the embodiments of the disclosure. Any minor modifications, equivalent changes, and modifications made to the above embodiments based on the technical solutions of the disclosure are within a scope of the technical solutions of the disclosure.

What is claimed is:

1. A magnetic inflation device, comprising:
an inflating base, comprising an inflating base main body, a valve core, an elastic member and a first magnetic member, wherein the inflating base main body defines a valve cavity therein, and the inflating base main body defines a first gas channel and a second gas channel connected to the valve cavity; the valve core and the elastic member are mounted in the valve cavity, and a lower end of the valve core extends into the first gas channel; the elastic member is configured to apply elastic force to the valve core to force the valve core to press downwards to close the first gas channel; and the first magnetic member is mounted in the inflating base main body; and
an inflating head, comprising an inflating head main body, wherein the inflating head main body is configured to dock or separate from the inflating base main body, the inflating head main body defines a third gas channel cooperating with the first gas channel, an upper end of the third gas channel is configured to lift the lower end of the valve core upwards and force the valve core to move upwards against the elastic force of the elastic member to open the first gas channel; and a second magnetic member is mounted in the inflating head main body, the second magnetic member is magnetically matched with the first magnetic member, and magnetic force between the first magnetic member and the second magnetic member is greater than the elastic force applied by the elastic member to the valve core.

2. The magnetic inflation device as claimed in claim 1, wherein a middle of the valve core is provided with a valve core sheet body protruding outwards, a lower side of the valve core sheet body defines a first annular positioning groove, a first sealing ring is mounted in the first annular positioning groove, a lower side of the first sealing ring is configured to cooperate with a top of the first gas channel, and the first sealing ring is sealed with the top of the first gas channel when the valve core is pressed down.

3. The magnetic inflation device as claimed in claim 2, wherein a cylinder is disposed on the lower end of the valve core, the cylinder defines a cylinder middle hole, an upper end of the cylinder defines a plurality of first gas passage holes connected to the cylinder middle hole, and each of the plurality of first gas passage holes is located on a lower side of the first annular positioning groove.

4. The magnetic inflation device as claimed in claim 3, wherein an upper end of the first gas channel defines an annular gas passage groove, and a position of the annular gas passage groove corresponds to a position of the plurality of first gas passage holes; and a lower end of the cylinder defines a plurality of second gas passage holes connected to the cylinder middle hole, and the plurality of second gas passage holes are located below the plurality of first gas passage holes.

5. The magnetic inflation device as claimed in claim 2, wherein the elastic member is a spring, the spring is sleeved on an upper end of the valve core, a lower end of the spring is abutted against an upper side of the valve core sheet body, and an upper end of the spring is abutted against a top of the valve cavity.

6. The magnetic inflation device as claimed in claim 2, wherein a plurality of ribs are convexly disposed on an inner wall of the valve cavity, and an outer side of the valve core sheet body is in sliding contact with the plurality of ribs.

7. The magnetic inflation device as claimed in claim 1, wherein the inflating base main body comprises an inflating base body and an inflating base cover body, the inflating base cover body covers a lower side of the inflating base body, and a second sealing ring is mounted between the inflating base cover body and the inflating base body; and the valve cavity is located in the inflating base body, the first gas channel is defined on a middle part of the inflating base cover body, and the second gas channel is defined on an upper part of the inflating base body.

8. The magnetic inflation device as claimed in claim 7, wherein the inflating base body and the inflating base cover body are clamped or bonded with each other; the inflating base cover body defines a first annular magnet groove, and the first annular magnet groove is located on an outer periphery of the first gas channel; the first magnetic member is an annular magnet, and the first magnetic member is mounted in the first annular magnet groove; the inflating head main body defines a second annular magnet groove, and the second annular magnet groove is located on an outer periphery of the third gas channel; the second magnetic member is an annular magnet, and the second magnetic member is mounted in the second annular magnet groove; and a magnet groove cover body is disposed in the second annular magnet groove, and the magnet groove cover body covers a lower side of the second magnetic member and is tightly matched with the second annular magnet groove.

9. The magnetic inflation device as claimed in claim 6, wherein an upper end of the inflating head main body defines a second annular positioning groove, and the second annular positioning groove is located on an outer periphery of the upper end of the third gas channel; and a third sealing ring is mounted in the second annular positioning groove, and an upper side of the third sealing ring is abutted against a bottom of the first gas channel when the upper end of the third gas channel lifts the lower end of the valve core upwards.

10. An inflating and deflating method of the magnetic inflation device as claimed in claim 1, comprising:
step I, performing a mounting process, comprising: mounting the inflating base on an inflatable product to make the first gas channel of the inflating base main body face towards an outside of the inflatable product, and make the second gas channel of the inflating base main body face towards an inside of the inflatable product; and connecting the inflating head and a gas supply device;
step II, performing an inflating process, comprising:
step i, placing an upper end of the inflating head close to a lower end of the inflating base, so that the inflating head and the inflating base are closely attracted together under a magnetic attraction effect of the first magnetic member and the second magnetic member, an upper end of the third gas channel synchronously lifts the lower end of the valve core in the first gas channel upwards to force the valve core to move upwards against the elastic force of the elastic member to open the first gas channel and connect the third gas channel and the first gas channel;
step ii, starting the gas supply device to make gas sequentially pass through the third gas channel, the first gas channel, the valve cavity and the second gas channel, and then enter the inside of the inflatable product until inflation is completed; and
step iii, pulling open the inflating head, so that the valve core is pressed downwards under the elastic force of the elastic member to close the first gas channel; and
step III, performing a deflating process, comprising: when the inflatable product needs to be deflated, pressing the lower end of the valve core in the first gas channel upwards by a hand or an object to force the valve core to move upwards against the elastic force of the elastic member to open the first gas channel, to make the gas in the inflatable product sequentially pass through the second gas channel, the valve cavity and the first gas channel to be discharged to the outside of the inflatable product.
